(19) United States
(12) Patent Application Publication
(10) Pub. No.: US 2003/0117376 A1
(43) Pub. Date: Jun. 26, 2003

(54) Hand gesturing input device

(76) Inventor: Elen Ghulam, Vancouver (CA)

Correspondence Address: Geoffrey R. Myers, Esquire, Hall, Priddy, Myers & Vande Sande, Ste. 200, 10220 River Road, Potomac, MD, 20854, US

(21) Appl. No.: 10/023,863

(22) Filed: Dec. 21, 2001

(51) Int. Cl. G09G 5/00

(52) U.S. Cl. 345/173

(57) ABSTRACT

A handheld electronic device with touch sensitive pads optimized for use with one hand. In order to allow private and efficient entry of input into a handheld electronic device, the present invention uses touch sensitive pads on the sides of the handheld electronic device to interpret finger gestures. The touch sensitive pads are divided into sections, and software is used to interpret different finger gesture combinations on the sections of the touch sensitive pads, which produce text or issue commands to the handheld electronic device.

### FIELD

The present invention is directed toward the field of handheld electronic devices such as personal digital assistants (PDAs), mobile phones and the like. In particular, the present invention uses touch sensitive input pads to provide the user of a handheld electronic device with the ability to input data quickly and privately through different finger gestures of one hand.

### BACKGROUND OF THE INVENTION

As handheld electronic devices, such as PDAs and mobile phones, have become smaller and more prevalent, there is an increasing need for input devices distinct from the traditional keyboard and mouse to accommodate the size of these devices. Prior art input devices have attempted to address the need for alternative input using devices such as hand writing recognition, on-screen keyboard input using a stylus, or voice recognition. However, such input devices are neither as efficient or private as the keyboard. For example, voice recognition requires the user to speak, and therefore requires the user to disclose the contents of all input, such as an email, to those who are within listening distance. Additionally, input devices using handwriting recognition, or voice recognition are error prone. Therefore, there is a need for a handheld electronic device for inputting data that provides the privacy and efficiency of a keyboard, without the error rates of voice recognition and handwriting recognition.

Accordingly, it is an object of this invention to provide a device for efficient and private input of data into a handheld electronic device using one hand. It is a further object of this invention to provide the software to allow the user to use a set of character and finger gesture combinations or to create custom character and finger gesture combinations to produce text and issue commands to the handheld electronic device. It is still a further object of this invention to provide software that allows the user to specify the dominant hand for use of the handheld electronic device.

### SUMMARY OF THE INVENTION

The present invention provides the user of a handheld electronic device, such as a PDA or mobile phone with the ability to enter input through combinations of thumb, middle finger and index finger gestures on touch sensitive pads. The touch sensitive pads are fitted on each side of the handheld electronic device, or alternatively fitted to a jacket that can be attached to a standard handheld electronic device. Software is provided to interpret the positioning of the fingers on the touch sensitive pads as specific characters or instructions. Additionally, the touch sensitive pads may be used as a navigation device to move the cursor or navigate menus on the handheld electronic device.

In contrast to the prior art, the use of this input device allows the user to enter input without the need to tap with a stylus on the screen, which is often slower than the keyboard; to search for keys on a small virtual keyboard, which takes up valuable space on the handheld electronic device; or to speak, which preserves the privacy of the user. One advantage of the present invention is to enable efficient input into a handheld electronic device while maintaining the privacy of the user.

Preferably, there are four touch sensitive pads; two located on the left side and two on the right side of the handheld electronic device. Each of the touch sensitive pads extends from the front of the handheld electronic device around to the side to allow maximum surface area for finger placement. One set of touch sensitive pads may be placed closer to the top on the handheld electronic device for more ergonomic placement of the thumb when accommodating single-hand use.

Preferably, each of the four touch sensitive pads is divided into three sections where the fingers and thumb can be positioned. A combination of finger gestures on the different sections of the touch sensitive pads is then interpreted by software as different inputs.

### BRIEF DESCRIPTION OF THE DRAWINGS

Further features and advantages of the invention will be apparent from the following detailed description, given by way of example, of a preferred embodiment taken in conjunction with the accompanying drawings, wherein:

FIG. 1 is a front view of a PDA-type handheld electronic device;

FIG. 2 is a front view of a PDA-type handheld electronic device incorporating touch sensitive pads on the sides of the handheld electronic device;

FIG. 3 is perspective view of a PDA-type handheld electronic device incorporating touch sensitive pads;

FIG. 4 is a front view of a jacket for a handheld electronic device incorporating touch sensitive pads on the sides of the jacket;

FIG. 5 is a perspective view of a jacket for the handheld electronic device incorporating touch sensitive pads;

FIG. 6 is a perspective view of a reversible jacket for the handheld electronic device incorporating the touch sensitive pads; and

FIG. 7 is a perspective view of the opposite side of the reversible jacket in FIG. 6 for the handheld electronic device incorporating the touch sensitive pads.

### DETAILED DESCRIPTION OF THE INVENTION

The preferred embodiment comprises of a device for inputting information into a handheld electronic device using finger gestures on an input surface, for example touch sensitive pads, or buttons. A combination of different finger gestures on the input surface are interpreted in order to produce text and issue commands to the handheld electronic device.

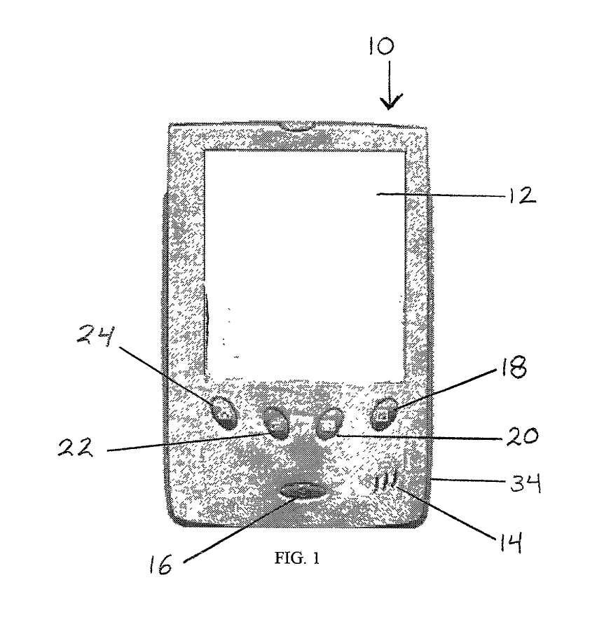

Referring to FIG. 1, a front view of a standard handheld electronic device 10 is shown. The handheld electronic device 10 comprises of a casing 34, a display screen 12, a speaker 14, an on-off button 16, and four buttons that perform various functions of the handheld electronic device 18, 20, 22, and 24.

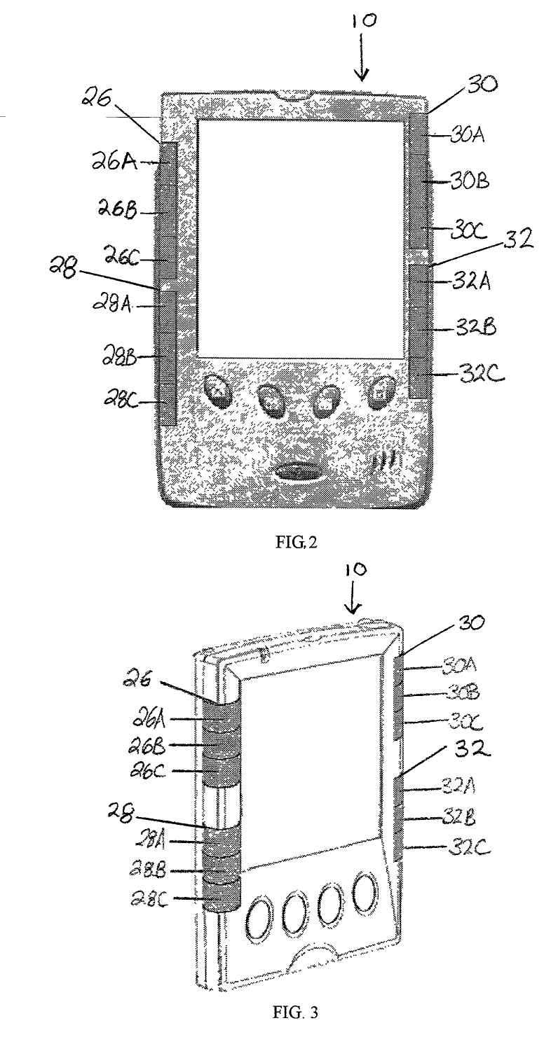

Referring to FIG. 2, a front view of the handheld electronic device 10, incorporating the touch sensitive pads 26, 28, 30, and 32 is shown. Touch sensitive pads 26 and 28 are located on the left side of the handheld electronic device 10, and touch sensitive pads 30 and 32 are located on the right side of the handheld electronic device 10. When the user holds the handheld electronic device 10 in the right hand the index finger will occupy touch sensitive pad 26; the middle finger will occupy touch sensitive pad 28; and the thumb will occupy either touch sensitive pad 30 or 32. Touch sensitive pads 30 and 32 are positioned closer to the top side of the handheld electronic device 10 than touch pads 26 and 28 to better accommodate the shape of the human hand for single-handed use with the right hand.

An alternative embodiment (not shown) of the handheld electronic device 10, could accommodate left hand use by positioning touch sensitive pads 26 and 28 closer to the top of the handheld device than touch sensitive pads 30 and 32. A further alternative embodiment may position the touch sensitive pads 26, 28, 30, and 32 evenly on each side of the hand held device 10. Further, an alternative embodiment may incorporate more or less than four touch sensitive pads on the handheld electronic device 10. However, at least three are required for the thumb, index finger and middle finger use.

Referring to FIG. 3, a perspective view of the handheld electronic device 10 incorporating the touch sensitive pads 26, 28, 30, and 32 is shown. The touch sensitive pads 26, 28, 30, and 32 extend around from the side of the handheld electronic device 10 to the front of the handheld electronic device 10 to provide maximum contact area for the fingers and thumb on the touch sensitive pads.

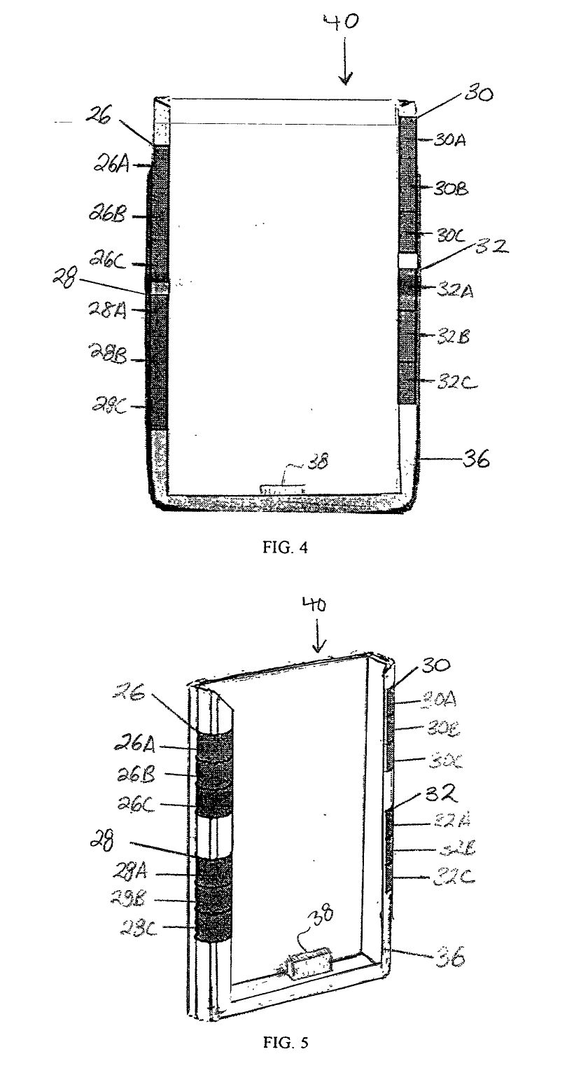

Referring to FIG. 4, a front view of a jacket 40 for a handheld electronic device is shown. The jacket 40 incorporates touch sensitive pads 26, 28, 30, and 32 that are connected to the jacket casing 36. The jacket 40 will fit over an existing handheld electronic device as an input mechanism, and connect to the handheld device using the docking port 38. Touch sensitive pad 26 and 28 are located on the left side, and touch sensitive pads 30 and 32 are located on the right side of the jacket 40. When the user holds the jacket 40 in the right hand the index finger will occupy touch sensitive pad 26; the middle finger will occupy touch sensitive pad 28; and the thumb will occupy either touch sensitive pads 30 or 32. Touch sensitive pads 30 and 32 are positioned closer to the top of the jacket 40 on the right side to better accommodate the shape of the human hand for single-handed use with the right hand.

An alternative embodiment (not shown) of the jacket 40, could accommodate left hand use of the handheld electronic device by positioning touch sensitive pads 26 and 28 closer to the top of the jacket than touch sensitive pads 30 and 32. An alternative embodiment may position the touch sensitive pads 26, 28, 30, and 32 evenly on each side of the jacket 40. Further, an alternative embodiment may incorporate more or less than four touch sensitive pads on the jacket 40. However, at least three are required for thumb, index finger and middle finger use.

Referring to FIG. 5, a perspective view of a jacket 40 comprising of the jacket casing 36, docking port 38, and touch sensitive pads 26, 28, 30, and 32 is shown. The touch sensitive pads 26, 28, 30, and 32 extend from the side of the jacket 40 to the front to provide of the jacket 40 to provide maximum surface contact for the fingers and thumb on the touch sensitive pads.

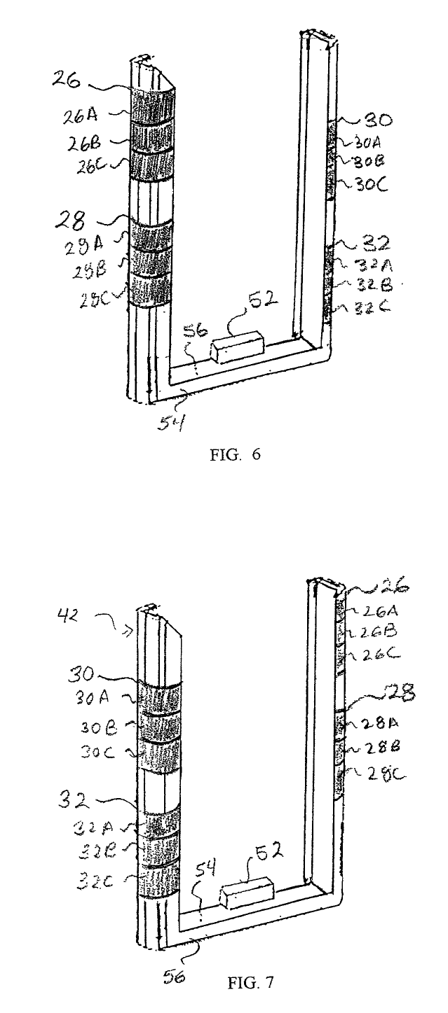

An alternative embodiment to the jacket 40 in FIGS. 4 and 5 is a reversible jacket 42 as shown in FIGS. 6 and 7 comprising of a docking port 52, and touch sensitive pads 26, 28, 30, and 32. The docking port 52 is structured such that the pin receptors are compatible with the handheld electronic device 10 when the reversible jacket 42 is mounted for use on the first side 54 or on the opposite side 56. The touch sensitive pads 26, 28, 30 and 32 of the reversible jacket 42 extend from the first side 54 to the second side 56 of the reversible jacket 42, allowing for use by a right handed user or left handed user.

Referring to FIGS. 2, 3, 4, 5, 6, and 7 each touch sensitive pad 26, 28, 30, and 32 is divided into three sections: touch sensitive pad 26 is sectioned into 26A, 26B, and 26C, touch sensitive pad 28 is sectioned into 28A, 28B, and 28C; touch sensitive pad 30 is sectioned into 30A, 30B, and 30C; and touch sensitive pad 32 is sectioned into 32A, 32B, and 32C. An alternative embodiment may divide each touch sensitive pad into more or less than three sections.

Optimally, software designed to interpret combinations of finger gestures on different sections of the touch sensitive pads 26, 28, 30, and 32 is incorporated into handheld device 10. The software will produce text and issue commands to the handheld electronic device. The software may also be designed to enable the touch sensitive pads to be used as a navigational device to move the cursor on the screen of the handheld electronic device. TABLE 1 represents one possible mapping scheme for character and finger gesture combinations for use of the handheld electronic device 10, jacket 40, or reversible jacket 42 in the right hand. The mapping scheme could be changed to accommodate left hand use of the handheld electronic device 10, jacket 40 or reversible jacket 42. Software of an alternative embodiment of the handheld electronic device 10, jacket 40 and reversible jacket 42 may not only allow the user to select the dominant hand of use, but also allow the user to create custom finger gesture combinations.

Obviously, other assignments of touch sensitive pads 26, 28, 30, and 32 could be used. Moreover, the handheld electronic device 10 could also be a controller with multiple outputs.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to the description. It is therefore contemplated that the appended claims will cover any such modifications or embodiments as fall within the true scope of the invention.

TABLE 1
Finger Gesture Mapping Scheme

| | Finger Gesture |
|---|---|
| Character | Combinations |
| A | 26A |
| B | 26B |
| C | 26C |
| D | 26A, 28A |
| E | 26A, 28B |
| F | 26A, 28C |
| G | 26B, 28A |
| H | 26B, 28B |
| I | 26B, 28C |
| J | 26C, 28A |
| K | 26C, 28B |
| L | 26C, 28C |
| M | 26A, 28A, 30A or 32A |
| N | 26A, 28A, 30B or 32B |
| O | 26A, 28A, 30C or 32C |
| P | 26A, 28B, 30A or 32A |
| Q | 26A, 28B, 30B or 32B |
| R | 26A, 28B, 30C or 32C |
| S | 26A, 28C, 30A or 32A |
| T | 26A, 28C, 30B or 32B |
| U | 26A, 28C, 30C or 32C |
| V | 26B, 28A, 30A or 32A |
| W | 26B, 28A, 30B or 32B |
| X | 26B, 28A, 30C or 32C |
| Y | 26B, 28B, 30A or 32A |
| Z | 26B, 28B, 30B or 32B |
| @ | 26B, 28B, 30C or 32C |
| ? | 26C, 28A, 30A or 32A |
| # | 26C, 28A, 30B or 32B |
| 0 | 26C, 28A, 30C or 32C |
| 1 | 26C, 28B, 30A or 32A |
| 2 | 26C, 28B, 30B or 32B |
| 3 | 26C, 28B, 30C or 32C |
| 4 | 26C, 28C, 30A or 32A |
| 5 | 26C, 28C, 30B or 32B |
| 6 | 26C. 28C, 30C or 32C |
| 7 | 26A, 28A, 30A or 32A |
| 8 | 26A, 28A, 30B or 32B |
| 9 | 26A, 28A, 30C or 32C |

What is claimed is:

1. A handheld electronic device comprising:
(a) a casing with a front portion and a first elongated side;
(b) a display screen visible on said front portion of said casing; and
(c) a touch sensitive pad on said first elongated side of said casing, said touch sensitive pad having a plurality of sections, each of said sections corresponding to a respective input to said handheld electronic device.

2. A handheld electronic device, comprising:
(a) a casing with a front portion, a first elongated side, and a second elongated side;
(b) a display screen visible on said front portion of said casing;
(c) a first touch sensitive pad on said first elongated side of said casing, said first touch sensitive pad having a plurality of sections, each of said sections corresponding to a first respective input to said handheld electronic device; and
(d) a second touch sensitive pad on said second elongated side, said second elongated side being on an opposite side of said first elongated side, said second touch sensitive pad having a plurality of sections, each of said sections corresponding to a second respective input to said handheld electronic device.

3. The handheld electronic device of claim 2, wherein said first touch sensitive pad is positioned closer to a top of said handheld device than said second touch sensitive pad, so that said first touch sensitive pad is in contact with a thumb of a user when said handheld electronic device is being gripped by a hand of said user.

4. The handheld electronic device of claim 2, wherein said first elongated side of said casing includes a third touch sensitive pad located on said first elongated side of said casing, said third touch sensitive pad having a plurality of sections, each said section corresponding to a third respective input to said handheld electronic device.

5. The handheld electronic device of claim 2, wherein said first elongated side of said casing includes a third touch sensitive pad located on said first elongated side of said casing, said third touch sensitive pad having a plurality of sections, each said section corresponding to a third respective input to said handheld electronic device, and said second elongated side of said casing includes a fourth touch sensitive pad, said second elongated side being on an opposite side of said first elongated side, said fourth touch sensitive pad having a plurality of sections, each of said sections corresponding to a second respective input to said handheld electronic device.

6. The handheld electronic device of claim 2, wherein said handheld electronic device has programmable software and a user-controllable input device so as to switch said handheld electronic device from accommodating a right-handed user to accommodating a left-handed user.

7. The handheld electronic device of claim 2, wherein each of said touch sensitive pads extends around a portion of said front portion of said casing, and along a corresponding elongated side thereof.

8. The handheld electronic device of claim 2, wherein the number of sections in each said plurality of sections is three.

9. The handheld electronic device of claim 2, wherein said handheld electronic device is a personal digital assistant.

10. The handheld electronic device of claim 2, wherein said handheld electronic device is a mobile phone.

11. A jacket for attachment to a handheld electronic device, comprising:
(a) a casing with a first elongated side;
(b) a docking port to electrically connect said casing to said handheld electronic device; and
(c) a touch sensitive pad on said first elongated side of said casing, said touch sensitive pad having a plurality of sections, each of said sections corresponding to a respective input to said jacket for relay to said handheld electronic device.

12. A jacket for attachment to a handheld electronic device, comprising:
(a) a casing with a first elongated side and a second elongated side;
(b) a docking port to connect said casing to said handheld electronic device;
(c) a first touch sensitive pad on said first elongated side of said casing, said first touch sensitive pad having a plurality of sections, each of said sections corresponding to a respective input to said jacket for relay to said handheld electronic device; and
(d) a second touch sensitive pad on said second elongated side, said second elongated side being on an opposite side of said first elongated side, said second touch sensitive pad having a plurality of sections, each of said sections corresponding to a respective input to said jacket for relay to said handheld electronic device.

13. The jacket of claim 12, wherein said first touch sensitive pad is positioned closer to a top of said jacket than said second touch sensitive pad, so that said first touch sensitive pad is in contact with a thumb of a user when said jacket is being gripped by a hand of said user.

14. The jacket of claim 12, wherein said first elongated side of said casing includes a third touch sensitive pad located on said first elongated side of said casing, said third touch sensitive pad having a plurality of sections, each said section corresponding to a third respective input to said jacket for relay to said handheld electronic device.

15. The jacket of claim 12, wherein said first elongated side of said casing includes a third touch sensitive pad located on said first elongated side of said casing, said third touch sensitive pad having a plurality of sections, each said section corresponding to a third respective input to said jacket for relay to said handheld electronic device, and said second elongated side of said casing includes a fourth touch sensitive pad, said second elongated side being on an opposite side of said first elongated side, said fourth touch sensitive pad having a plurality of sections, each of said sections corresponding to a second respective input to said jacket for relay to said handheld electronic device.

16. The jacket of claim 12, wherein said jacket has a user-controllable input device so as to switch said handheld electronic device from accommodating a right handed user to accommodating a left handed user.

17. The jacket of claim 12, wherein each of said touch sensitive pads extends around a portion of the front of said casing, and along a corresponding elongated side thereof.

18. The jacket of claim 12, wherein said jacket is reversibly mountable to the handheld electronic device to accommodate left or right handed use.

19. The jacket of claim 12, wherein the number of sections in each said plurality of sections is three.

20. The jacket of claim 12, wherein the said jacket attaches to a personal digital assistant.

21. The jacket of claim 12, wherein the said jacket attaches to a mobile phone.
